(19) United States
(12) Patent Application Publication
(10) Pub. No.: US 2014/0313217 A1
(43) Pub. Date: Oct. 23, 2014

(54) DISPLAY CALIBRATION

(71) Applicant: Broadcom Corporation, Irvine, CA (US)

(72) Inventor: John S. WALLEY, Ladera Ranch, CA (US)

(21) Appl. No.: 13/942,597

(22) Filed: Jul. 15, 2013

Related U.S. Application Data
(60) Provisional application No. 61/814,738, filed on Apr. 22, 2013.

(51) Int. Cl. G09G 5/00

(52) U.S. Cl. CPC G09G 5/00
USPC 345/589

(57) ABSTRACT

A method of compensating for optical distortion on a display panel is provided. The method includes determining one or more pixels in a display that need compensation for optical distortion on a display panel. The method also includes generating a mapping of the display comprising location information of the one or more pixels determined to need optical distortion compensation. The method also includes generating a control signal based on the mapping to control one or more display characteristics of the one or more pixels. The control signal has scaled display values for the one or more display characteristics to reduce the optical distortion on the display panel. The method also includes outputting the control signal to the one or more pixels in the display.

### CROSS-REFERENCE TO RELATED APPLICATIONS

The present application claims the benefit of U.S. Provisional Patent Application Ser. No. 61/814,738, titled “DISPLAY CALIBRATION,” filed on Apr. 22, 2013, which is hereby incorporated by reference in its entirety for all purposes.

### BACKGROUND

Display technologies are continually advancing to improve display quality while also attempting to reduce the cost and size of displays. Display technologies including a touch panel and a display system are typically designed in isolation (e.g., as mechanically separate elements). These display technologies have a large impact on the size, quality and cost of the overall system (e.g., a communication device). The touch panel may be designed in multiple layers including metallization patterns that provide a conductive coating across the touch panel. In this regard, the touch panel may include a capacitance sensing technology that measures the electrostatic field near the surface of the touch panel.

The conductive coating, depending on its thickness and pattern, can distort the optical clarity of the touch panel. In turn, pixels can be blocked or obstructed by conductive layer traces found across the touch panel. As such, the brightness level is impacted. As display technologies decrease in size, the number of pixels experiencing distortion across the touch panel increases. Display techniques attempting to address distortion in display technologies can be realized notwithstanding substantial cost, area and performance penalties.

### SUMMARY

A system and/or method is provided for display calibration, substantially as illustrated by and/or described in connection with at least one of the figures, as set forth more completely in the claims.

### BRIEF DESCRIPTION OF THE DRAWINGS

Certain features of the subject technology are set forth in the appended claims. The accompanying drawings, which are included to provide further understanding, illustrate disclosed aspects and together with the description serve to explain the principles of the disclosed aspects. In the drawings:

FIG. 1 is a block diagram illustrating an example of a display system in accordance with one or more implementations.

FIGS. 2A-2B are diagrams illustrating examples of display systems in accordance with one or more implementations.

FIG. 3 is a diagram illustrating an example of a method flowchart in accordance with one or more implementations.

FIG. 4 is a diagram illustrating an example of a frequency response in accordance with one or more implementations.

FIGS. 5A-5C are diagrams illustrating examples of display calibration systems in accordance with one or more implementations.

FIG. 6 conceptually illustrates an electronic system with which any implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without one or more of these specific details. In one or more instances, structures and components are shown in block diagram form in order to avoid obscuring the concepts of the subject technology.

The subject technology relates to display calibration to compensate for optical distortion observed on a display panel. Optical distortion in display panel designs according to one or more implementations can be corrected (or compensated for) by having a display (e.g., liquid-crystal display (LCD), electronic ink (e-ink), luminescent) compensate for any loss in optical clarity caused by distortions due to content and frequency response and/or loss of color in the display panel. In this regard, rather than attempting to reduce distortions mechanically, the burden is moved from the display panel to the display itself using digital signal processing techniques. In some aspects, the display can be programmed (or controlled) using adjusted (or scaled) display values to provide an adjusted display output that compensates for the optical distortion on the display panel.

Knowing which pixels to reprogram can be determined in one or four ways: (1) using a camera to record images of an actual display to determine any variations on the display panel and using the images to generate a compensation map for display compensation (2) using a priori information of where optical distortions are likely to occur on the display panel to apply the display compensation, (3) using a priori information to determine offset information between the display and display panel, (4) using embedded optical sensors to collect variations in received light at the display to determine locations on the display panel with optical distortion. In turn, the display calibration via the display using processing algorithms can help achieve thinner conductive layering, and reduce the overall system cost without substantially impacting display quality.

In one or more implementations, a method of compensating for optical distortion on a display panel is provided. The method includes determining one or more pixels in a display that need compensation for optical distortion on a display panel. The method also includes generating a mapping of the display comprising location information of the one or more pixels determined to need optical distortion compensation. The method also includes generating a control signal based on the mapping to control one or more display characteristics of the one or more pixels. The control signal has scaled display values for the one or more display characteristics to reduce the optical distortion on the display panel. The method also includes outputting the control signal to the one or more pixels in the display.

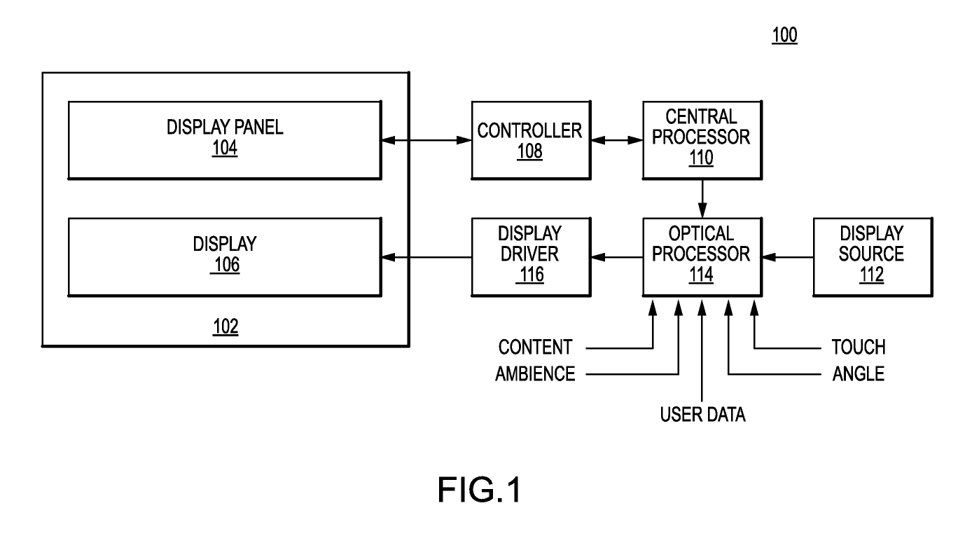

FIG. 1 is a block diagram illustrating an example of display system 100 in accordance with one or more implementations. System 100 includes display system 102, controller 108, central processor 110, display source 112, optical processor 114 and display driver 116. Display system 102 includes display panel 104 and display 106. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Display panel 104 that may have multiple conductive layers arranged orthogonally to one another to form conductive layer traces (e.g., metallization electrical patterns) across display panel 104. Each of the conductive layers may have a distinct pattern. In one or more aspects, display panel may be configured as a touch panel. In this regard, the conductive layers may be composed of a metallization transparent material (e.g., Indium-Tin-Oxide (ITO) or micro-thin Copper) with a conductive property suitable for touch sensing technologies. The conductive layer may vary in thickness and width, which may impact the optical clarity through display panel 104.

Display 106 is located beneath display panel 104, and configured to project light towards display panel 104. Display 106 is coupled to display driver 116, and further coupled to optical processor 114 via display driver 116 using one or more connectors. Display 106 may be configured to receive display values from display driver 116 that cause display 106 to output light with display characteristics having the display values. Alternatively, display 106 may be controlled through a circuit board coupled to display 106 using one or more connectors (not shown). Display 106 may be a liquid-crystal display, a light-emitting display (LED), a plasma display, an organic light-emitting display (OLED), electronic ink, luminescent, or any display technology suitable for stationary or mobile electronic devices.

By way of illustration without limiting the scope of the subject technology, display 106 is shown as an LCD that has multiple pixel elements arranged in a grid. Display 106 may comprise a backlight feature that provides uniform illumination across display 106. The backlight feature may be adjusted to provide more or less brightness around the pixel elements in display 106. In one or more aspects, display panel 104 is coupled to display 106 using an adhesive material. Alternatively, display panel 104 and display 106 may be integrated as one element.

System 100 also includes controller 108 that is communicatively coupled to display panel 104. Controller 108 may be configured to receive user input information and provide control signals. In the case that display panel 104 is configured as a touch panel, controller 108 may receive touch sensing information from display panel 104 and communicate the touch sensing information to internal components (e.g., central processor 110, optical processor 114) using one or more connectors. Such connectors may be used to interface with a controller for a media device such as a handheld device or a stationary device. In one or more implementations, a mutual capacitive layer may be included in display panel 104 such that the touch sensing information may include a touch location on or above the mutual capacitive layer.

Non-limiting examples of a media device include, but not limited to, a laptop computer, desktop computer, notepad, notebook, ultrabook, tablet, cellular telephone, personal digital assistant (PDA), STB, digital camera, portable media player, monitor or any other electronic device configured to display information, images and/or video.

In one or more aspects, controller 108 may perform electrical measurements of display panel 104 to estimate a thickness of one or more conductive layers in display panel 104 or variations between patterns of the one or more conductive layers. Controller 108 may be configured to facilitate increases in resistance of display panel 104 as the thickness of the one or more conductive layers decrease.

System 100 also includes central processor 110 communicatively coupled to controller 108 and configured to mapping information of display panel 104 and display 106. Optical processor 114 is communicatively coupled to central processor 110 and display source 112. Display source 112 may be configured to supply display source material or content to display 106. Optical processor 114 may be configured to receive the display source material from display source 112 and generate a display configuration signal based on one or more optical properties. System 100 also includes display driver 116 coupled to optical processor 114 and display 106. Display driver 116 may be configured to receive and pass the display configuration signal from optical processor 114 to display 106.

In one or more aspects, the optical properties include, but are not limited to, touch-based inputs, ambient-based inputs, angle-based inputs, content-based inputs and/or user-based inputs. Touch-based inputs may include sense information of a touch object making contact with display system 102. Ambient-based inputs may include the amount of color in a room or surrounding environment for adjusting the color brightness per pixel or screen overall. Angle-based inputs may include viewing angle measurements, brightness levels and contour information along an x-y plane for different viewing angles to determine a calibration of the measured pupil viewing angle. Content-based inputs may include content information (e.g., motion estimation, contrast measurements, brightness measurements, frame information) to distort brightness variations in the content to save power versus quality or improve contrast of picture.

User-based inputs may include the users preferences, user recognition data, and user vision capabilities. The user preferences may describe the preferred levels of colorization, contrast and/or brightness of display 106. The user recognition data may include identification information of a particular user, and operate as an extension to the user preferences. The user vision capabilities may take into account whether the colorization and/or brightness need to be increased or decreased if the user has certain vision impairments. In this regard, the user vision capabilities may be in conjunction with the user recognition data and/or user preferences.

In one or more aspects, central processor 110 may have knowledge of electronics located above display 106 such as conductive layer traces (sometimes referred to as touch metallization traces) included in display panel 104. Central processor 110 may include or be coupled to a digital signal processor (not shown) to generate a mapping of display panel 104 having an indication of where conductive layer traces in display panel 104 are located relative to pixels in display 106. As such, optical processor 114 may be configured to receive the mapping from central processor 110 along with the display source material to determine the display configuration signal.

If system 100 has knowledge of optical properties for display panel 104, then system 100 can compensate for optical distortions present on display panel 104. In this regard, optical processor 114 can utilize the mapping from central processor 110 to determine which pixels in display 106 are located beneath or near a conductive layer trace in display panel 104. As stated above, optical distortions may be observed on display panel 104 if pixels are obstructed by the conductive layer trace or display 106 is misaligned from display panel 104. As such, optical processor 114 can program the one or more pixels in display 106 with scaled display values to compensate for the optical distortion.

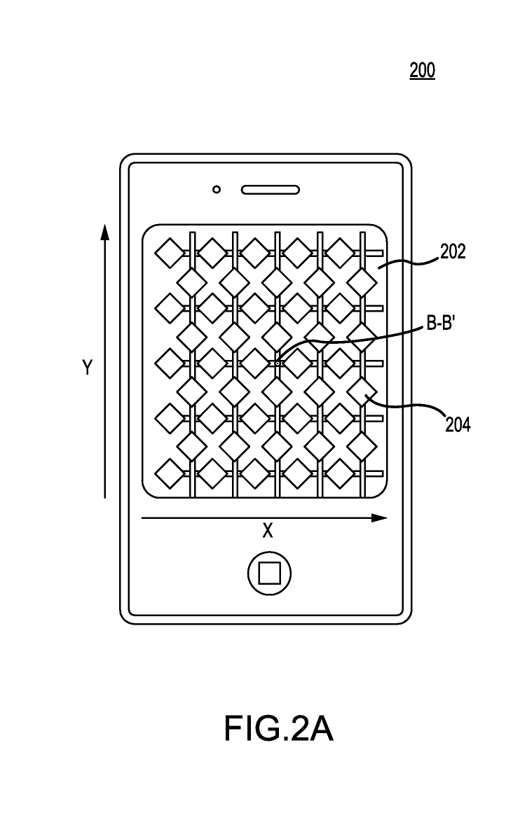

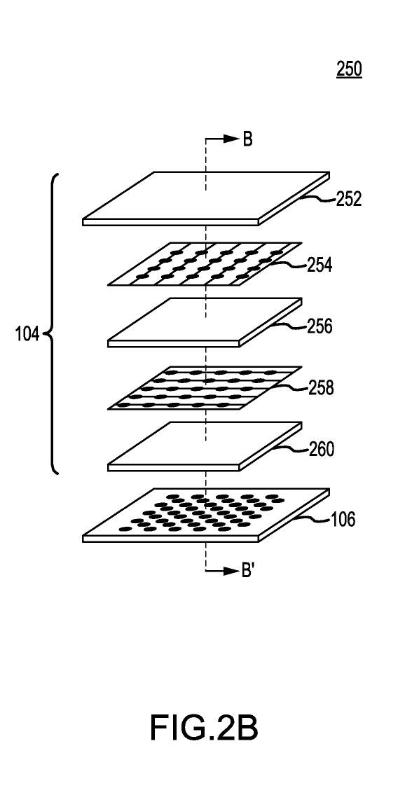

FIGS. 2A-2B are diagrams illustrating examples of display systems in accordance with one or more implementations. FIG. 2A is a top-view diagram illustrating an example of display system 200 in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

As shown, display system 200 includes display 202 having a display surface showing multiple conductive traces 204 arranged in columns (e.g., y-axis) and rows (e.g., x-axis). Each of conductive traces 204 may be configured as drive lines and sense lines. In particular, an array of sensing circuits (not shown) may be designated as containing multiple drive lines along the y-axis. Each drive line may include multiple individual drive electrodes, where drive signals are provided to the drive electrodes of each drive line. In such an implementation, a separate array may be designated as containing multiple sense lines along the x-axis (not shown). Each sense line may include multiple individual sense electrodes, where the drive signals provided to drive electrodes couple capacitively to the sense electrodes and produce corresponding sense signals. Such sense signals may be used by touch controller 108 to sense the presence of an object that produces a localized change in capacitance on display panel 104. The drive lines and sense lines, such as those shown in FIG. 2A, may be composed of the metallization transparent material, indium-tin-oxide (ITO) or micro-thin Copper.

The display surface showing an array of conductive traces 204, depending on their respective thickness and pattern, can distort the optical clarity of display panel 104. In one or more aspects, pixels in display 106 can be blocked or obstructed by the conductive layer traces (sometimes referred to as metallization electrical patterns) found across the display surface. That is, the conductive layer traces can absorb light thus causing a loss in brightness from display 106.

FIG. 2B is an exploded cross-section diagram illustrating an example of display system 250 in accordance with one or more implementations. Specifically, FIG. 2B presents the cross section of FIG. 2A taken at plane B-B′. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Display system 250 includes top film layer 252, conductive layer 254 (sometimes referred to as a polarizer layer), substrate film layer 256, conductive layer 258, bottom film layer 260, and display 106 (FIG. 1). In one or more aspects, display 106 is integrated with display panel 104 as one element in display system 250. In one or more aspects, display 106 and display panel 104 are separate elements in display system 250.

In one or more implementations, each of conductive traces 204 may be configured as a polarizer to optically filter display 106 such that an optical wave of a specific polarization passes through top film layer 252 of display panel 104 and blocks optical waves of other polarizations.

Display 106 is located beneath bottom film layer 260. Bottom film layer 260 located beneath conductive layer 258 and disposed over display 106. Conductive layer 258 is located beneath substrate film layer 256 and disposed over bottom film layer 260. Substrate film layer 256 is located beneath conductive layer 254 and disposed over conductive layer 258. In one or more aspects, conductive layers 254 and 258 may be integrated into substrate film layer 256. Conductive layer 254 is located beneath top film layer 252 and disposed over substrate film layer 256. Top film layer 252 protects all underlying components.

As shown in FIG. 2B, display system 250 may include top film layer 252, substrate film layer 256 and bottom film layer 260, each layer being approximately 0.7 mm thick, for example. In one or more aspects, each layer may be a different thickness. Display system 250 may further include top and bottom adhesive layers, respectively, configured to adhere adjacent film layers with sense line and drive line ITO electrical patterns (sometimes referred to as conductive traces). In one or more aspects, conductive layers 254 and 258 may be 1 micron thick, and all adhesive layers may be 25 microns thick.

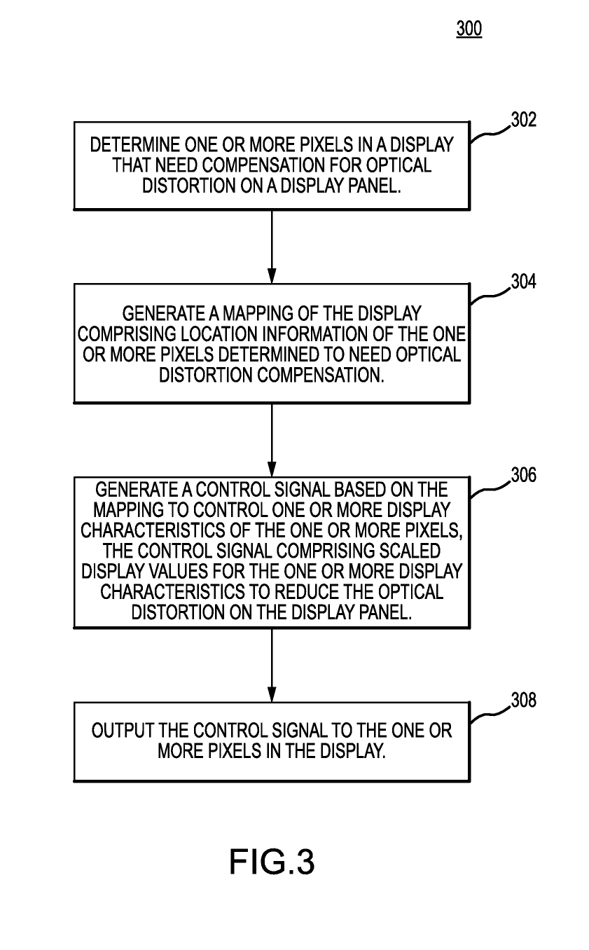

FIG. 3 is a flowchart illustrating an example of method 300 of optical processor 114 in accordance with one or more implementations. For explanatory purposes, the example method 300 is described herein with reference to optical processor 114 of system 100 of FIG. 1; however, method 300 is not limited to optical processor 114 of system 100 of FIG. 1, and method 300 may be performed by one or more components of optical processor 114. Further for explanatory purposes, the blocks of method 300 are described herein as occurring in serial, or linearly. However, multiple blocks of method 300 may occur in parallel. In addition, the blocks of method 300 need not be performed in the order shown and/or one or more of the blocks of method 300 need not be performed.

Method 300 can be implemented by optical processor 114 to compensate for optical distortion on display panel 104 that is coupled to display 106. Display 106 is configured to emit light beams through display panel 104 that may be obscured by one or more factors including, but not limited to, optical clarity of antenna panels (sometimes referred to as conductive layers) disposed in display panel 104, conductive layer material, a type of metallization pattern in the conductive layering, the width of the metallization pattern, and the thickness of the conductive layer material. In one or more aspects, optical processor 114 (FIG. 1) may be configured to execute processor-executable instructions that cause optical processor 114 to perform operations that include method 300.

Optical processor 114 may be configured to determine one or more pixels in display 106 that need compensation for optical distortion on display panel 104 (302). In this respect, there are exemplary ways to determine where antenna panels or conductive layer traces are located on display panel 104 relative to the pixels in display 106. In determining the one or more pixels that need optical distortion compensation, optical processor 114 may be configured to receive a priori information of one or more conductive layer traces located in the display panel. In this regard, the one or more conductive layer traces may be aligned with the one or more pixels in the display.

In receiving the a priori information, optical processor 114 may be configured to receive dimensional and location information of the one or more conductive layer traces. Particularly, optical processor 114 may be configured to receive dimensional and location information of a conductive layer trace in the display panel. In receiving the dimensional and location information, optical processor 114 may be configured to receive thickness and width information of the conductive layer trace. In turn, optical processor 114 may determine the amount of light the conductive layer trace can absorb based on its thickness.

In obtaining the thickness information, optical processor 114 may determine a resistivity of the conductive layer trace using electrical measurements obtained by controller 108. As such, optical processor 114 can be configured to determine the thickness based on the measured resistivity. In one or more aspects, controller 108 may be configured to determine the resistivity and determine a thickness of the conductive layer trace based on the measured resistivity.

In receiving the dimensional and location information, optical processor 114 may be configured to receive a two-dimensional coordinate (e.g., x, y) of the display panel that indicates where the conductive layer trace is above or near the obstructed pixel. In this regard, optical processor 114 can determine the number of pixels located beneath the conductive layer trace and further determine the number of pixels impacted by the conductive layer trace.

In some aspects, optical processor 114 may be configured to receive a priori information that includes offset values based on location differences between the one or more pixels and the one or more conductive layer traces. In this regard, the one or more conductive layer traces are misaligned with the one or more pixels. As such, optical processor 114 may be configured to process the a priori information with long-term statistical averages of user inputs received via display panel 104 to determine one or more offsets between the one or more pixels and the one or more conductive layer traces.

In one or more implementations, a camera may be utilized to capture images of display panel 106. The camera may be coupled to a digital signal processor that is configured to generate image data based on the captured images. In addition, optical processor 114 may receive the image data and be configured to generate long-term statistical averages of the image data to determine expected display characteristics of the one or more pixels. In this regard, optical processor 114 may compare actual display characteristics of the one or more pixels based on the image data with the expected display characteristics of the one or more pixels based on the long-term statistical averages to determine one or more locations on display panel 104 with optical distortion.

In some implementations, optical sensors may be disposed in display 106 relative to pixels located across display 106. As such, optical processor 114 may be configured to receive sensor information from one or more optical sensors for determining the one or more pixels that need optical distortion compensation. The sensor information may include optical measurements of natural light received at the one or more pixels via display panel 104. In some aspects, the optical sensors may be photo diodes configured to detect light and record intensity values of the detected light.

Based on the sensor information, optical processor 114 may determine if one or more pixels in display 106 are located beneath or near one or more conductive layer traces. In addition, optical processor 114 may be configured to determine one or more pixels located adjacent to the one or more pixels located beneath or near the one or more conductive layer traces. In this regard, optical processor 114 may control the adjacent pixels differently than the pixels located beneath or near the one or more conductive layer traces. For example, the adjacent pixels receive scaled display values that are different than the one or more pixels obstructed by the one or more conductive layer traces. In addition, optical processor 114 may be configured to determine a gain to adjust the one or more display characteristics of the one or more pixels by a defined percentage. For example, optical processor 114 may require increasing the display characteristics of the one or more pixels by 10% uniformly across display 106.

In some implementations, optical processor 114 may cause the optical sensors to scan display 106 to locate one or more pixels that are located beneath or near the conductive layer trace. A single pixel or multiple pixels may be located beneath or near the conductive layer trace. The size of the pixel may greater than the width of the conductive layer trace or may be less than the width of the conductive layer trace (e.g., 400-500 dots per inch).

In some aspects, optical processor 114 may be configured to generate a mapping of display 106 including location information of the one or more pixels determined to need optical distortion compensation (304). In some aspects, central processor 110 may be configured to generate the mapping and provide the mapping to optical processor 114. The mapping may be a template that provides coordinate information of the pixels disposed in display 106. The mapping also may provide optical measurements for each of the pixels that indicate which pixels are being obstructed by the conductive layer traces of display panel 104. Optical processor 114 may utilize the mapping along with a display source material from display source 112 that provides colorization parameters (e.g., red, blue, green) to determine scaled display values. The scaled display values can include adjustments to the colorization parameters that increase or decrease the display characteristics of the pixels.

In some aspects, optical processor 114 may be configured to determine a frequency response of a display characteristic for a given pixel in display 106 that is located beneath the conductive layer trace based on the dimensional and location information. In this respect, the frequency response may be in addition to the mapping that provides the template for adjustments to be made in display 106. The frequency response may be a plot of the display behavior over a number of frequencies. The frequencies represent the spectrum of colors, including visible and non-visible light, emitted by display 106. The frequency response may provide a glimpse to determine any variations in performance, such as certain color brightness experiencing optical distortion when the transmittance level is lower than expected at a certain wavelength.

In determining the frequency response, optical processor 114 may be configured to determine an amplitude level of a display characteristic (e.g., brightness) for each of a number of frequencies available in the frequency response based on the thickness of the conductive layer trace. As stated above, the frequency response may represent the output performance of a given pixel in display 106 as a function of frequency (or wavelength), depending on implementation. The frequency response can provide plots for different thicknesses of the conductive layer trace since the thickness of the conductive layer impacts how much transmittance can be realized for a given frequency.

In one or more aspects, the display characteristic may include a transmittance level and a colorization level. The transmittance level may relate to the amount of light that passes through the conductive layer trace (e.g., intensity), and the colorization level relates to the amount of polarization filtered through the conductive layer trace. As such, the transmittance level and the colorization level may be impacted at certain wavelengths (or frequencies) or with certain thicknesses. In some implementations, the transmittance level and colorization level are increasingly impacted as the conductive layer trace increases in thickness. However, if the thickness is decreased, the transmittance level and colorization level are increasingly impacted for relatively shorter wavelengths. In this regard, the subject technology relates to adjusting the frequency response while maintaining relatively thinner conductively layer traces. In some implementations, the display characteristic can include a contrast level and a brightness level.

In calibrating the pixel in display 106, optical processor 114 may be configured to generate the frequency response based on the transmittance level determined individually for respective ones of the frequencies. Similarly, the frequency response may be generated based on the colorization level determined individually for the respective ones of the frequencies. As stated above, the transmittance level and colorization level may be determined using electrical measurements (e.g., resistivity) and optical properties (e.g., thickness) of the conductively layer trace. In one or more aspects, such computations may be performed by optical processor 114. Alternatively, such computations may be performed by controller 108 or any other processor coupled to display panel 104.

In some aspects, optical processor 114 may be configured to generate a control signal based on the mapping to control one or more display characteristics of the one or more pixels (306). In this regard, the control signal includes scaled display values for the one or more display characteristics to reduce the optical distortion on display panel 104. In some aspects, the display values including the scaled display values have a common format. By way of example, the format may identify the two-dimensional coordinate of the pixel in display 106 including the colorization parameters Red (R), Green (G), and Blue (B). As such, the format may be expressed as data_{(x,y)} (R,G,B). Similarly, the format for the scaled display values may be expressed as data_{(x,y)} (R′, G′, B′), however, the colorization parameters may include adjusted values to represent the scaling from the original display values. In some aspects, the scaled display value may include the original display value multiplied by a factor (e.g., B′=B*1.1).

Optical processor 114 may be configured to generate the scaled display values based on the a prior information of where optical distortion compensation is needed. That is, optical processor 114 may provide the scaled display values to target those pixels known to be located beneath or near a conductive layer trace. The control signal may not include scaled display values for pixels that are located outside the conductive layer trace or are not being obstructed by the conductive layer trace.

As noted above, if optical properties of display panel 104 are known (e.g., where ITO traces are located, thickness of ITO), then distortions observed on display panel 104 can be compensated for using display 106. In generating the control signal, optical processor 114 may be configured to determine the scaled display values for one or more frequencies of the frequency response to alter the one or more display characteristics of the one or more pixels from original display values to the scaled display values. For the pixels located beneath or near the ITO material (e.g., conductive layer trace), the optical distortion with respect to these pixels may be compensated by boosting (or increasing) the frequency response. In calibrating the color of the pixel, for example, the brightness of the pixel in display 106 can be increased at certain wavelengths to achieve a flat colorization in the frequency response. In one or more aspects, the correction value may be the difference between a measured colorization level and an expected colorization level for that wavelength. Similarly, the correction value may relate to the difference between a measured transmittance level and the expected transmittance level at that wavelength. That is, the correction value is the amount of increase needed to achieve a substantially flat frequency response.

In addition, method 300 may include analyzing the frequency response to identify one or more frequencies associated with the display characteristic that is less than a first threshold. In one or more aspects, the first threshold relates to the magnitude needed to maintain a substantially flat frequency response for given frequencies (or wavelengths). Upon determining at what frequencies to make adjustments, method 300 may include calculating a first gain to increase the display characteristic above the first threshold at the one or more frequencies.

Here, the first gain relates to the amount needed to reach the first threshold to achieve the flat frequency response. In one or more aspects, the first gain may be a magnitude to increase the colorization level. Alternatively, the first gain may be a magnitude to increase the transmittance level (sometimes referred to as the brightness). Method 300 also may include applying the first gain to the pixel via the control signal. Applying the first gain may refer to an instruction that programs the pixel.

Display 106 may include a backlighting feature that increases the brightness level uniformly across the pixels in display 106. In addition, the backlighting feature may apply to increasing the brightness level uniformly for multiple frequencies. As such, method 300 may include calculating a second gain relating to the backlighting feature to increase the display characteristic (e.g., colorization, brightness) by a defined percentage simultaneously for a number of frequencies or number of pixels. In one or more aspects, the backlighting feature may be performed simultaneously with increasing the colorization or brightness levels of individual pixels.

As will be discussed further below, the backlighting feature may be performed simultaneously to increase frequency responses of individual pixels located beneath or near conductive layer traces as well as adjustments to decrease the frequency responses of pixels located adjacent to the obstructed pixels (e.g., pixels located beneath or near the conductive layer traces) as techniques to correct for display distortion according to one or more implementations of the subject technology.

Method 300 includes outputting the control signal to the one or more pixels in the display (308). In outputting the control signal, optical processor 114 may be configured to supply the mapping of display 106 in the control signal to locate the one or more pixels that need the optical distortion compensation. In this regard, the control signal may include location information of the pixel such as a coordinate location in the x-y plane. The control signal with the scaled display values may be sent to the one or more pixels determined to be located beneath or near the one or more conductive layer traces. The adjacent pixels may receive scaled display values that are different than the one or more pixels obstructed by the one or more conductive layer traces.

Optical processor 114 can program the pixel in display 106 to increase its colorization or brightness levels using the scaled display values. In one or more aspects, the pixels in display 106 can be calibrated individually such that adjustments to display 106 are performed on a pixel-per-pixel basis. Alternatively, the pixels in display 106 can be calibrated collectively via the control signal. In this regard, groups of pixels can receive the same scaled display value.

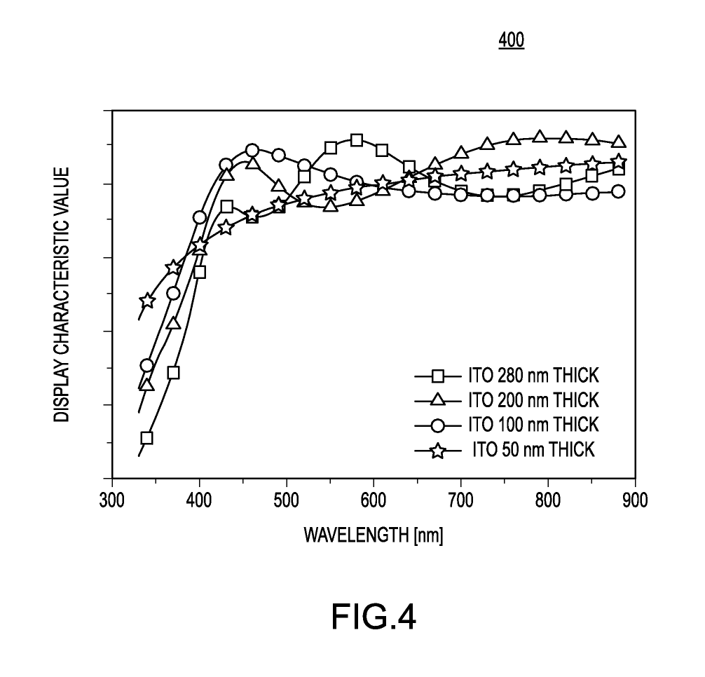

FIG. 4 is a diagram illustrating an example of a frequency response 400 in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Frequency response 400 includes multiple plots of a display characteristic (shown along the y-axis) as a function of wavelength (shown along the x-axis). The wavelength may be in terms of nanometers to represent the visible light spectrum (e.g., blue colorization around 400 nm, red colorization around 800 nm). As such, frequency response 400 may show a response for ITO metallization showing the loss in transmittance for different colors. Frequency response 402 relates to an ITO metallization thickness of 50 nm. Frequency response 404 relates to an ITO metallization thickness of 100 nm, for example. Frequency response 406 relates to an ITO metallization thickness of 200 nm, for example. Frequency response 408 relates to an ITO metallization thickness of 280 nm, for example.

In this regard, frequency response 400 may represent the performance of a pixel in display 106, depending on implementation, for different thicknesses. The thickness of the conductive layer impacts the frequency response, and therefore, the frequency response varies for different thicknesses. In one or more aspects, frequency response 400 may be a function of frequency (ω).

Optical processor 114 may be configured to determine frequency response 400 by first determining a magnitude level of a display characteristic for each of a number of frequencies available in the frequency response based on the thickness of the conductive layer trace. The plot of frequency response 400 may be generated using multiple electrical measurements including transmittance level measurements and colorization level measurements at one or more frequencies (or wavelengths). Touch controller 108 may be configured to obtain the electrical measurements from display panel 104.

Depending on the thickness of the conductive layer trace being analyzed, a different frequency response may be plotted since the thickness impacts the performance of the pixel at varying frequencies (or wavelengths). In one or more aspects, the performance of the pixel with respect to a relatively thin trace may be lower than the performance of a pixel with respect to a trace having a larger thickness. As shown in FIG. 4, the performance differences become more prevalent at the smaller wavelengths (e.g., 300 nm compared to 600 nm).

In analyzing frequency response 400, optical processor 114 can determine a scaled display value that increases or decreases the display characteristic of the one or more pixels at one or more frequencies of frequency response 400 such that the optical distortion on display panel 104 can be reduced. In one or more aspects, the display characteristic relates to the brightness level of the one or more pixels. In one or more aspects, the display characteristic relates to the colorization level of the one or more pixels.

Because the conductive layer traces affect optical clarity, pixels located beneath or near a conductive layer trace are likely to need some color or brightness correction. As such, the measured distortion at these pixels can be compensated by increasing the frequency response according to the correction value (e.g., increasing the magnitude of transmittance or colorization depending on implementation) at certain wavelengths to achieve a substantially flat frequency response. Optical processor 114 also may output the correction value via optical data that is sent to display driver 116 and then to display 106.

In areas not under a conductive layer trace where the transmittance level is higher than those areas impacted by the conductive layer trace, those sets of pixels can be programmed to reduce their brightness level. In one or more aspects, the processor is configured to output a second control signal to the display that adjusts adjacent pixels of the one or more pixels located beneath or near the conductive layer traces. The adjacent pixels may have a brightness level that is greater than the pixels located beneath or near the conductive layer traces. As such, the second control signal causes a decrease in magnitude of the display characteristic (e.g., brightness, colorization) for the adjacent pixels.

In one or more aspects, optical processor 114 may be configured to output the first and second control signals at a same time to increase the brightness or colorization levels for pixels impacted by the conductive layer trace and reduce the brightness or colorization levels for those pixels not impacted at all to achieve uniform display quality and minimal distortion across display panel 104.

In addition to increasing the brightness and colorization levels of pixels located beneath or near conductive layer traces while decreasing the brightness level of adjacent pixels, the backlight feature of the display can be adjusted such that the brightness is increased uniformly across the display as a further adjustment feature. In this regard, optical processor 114 may be configured to output a third control signal to the display that adjusts the display characteristic uniformly across the display by a defined percentage. Alternatively, the optical distortion can be corrected by combining the adjustments made on a pixel-by-pixel basis with adjustments made to the backlight.

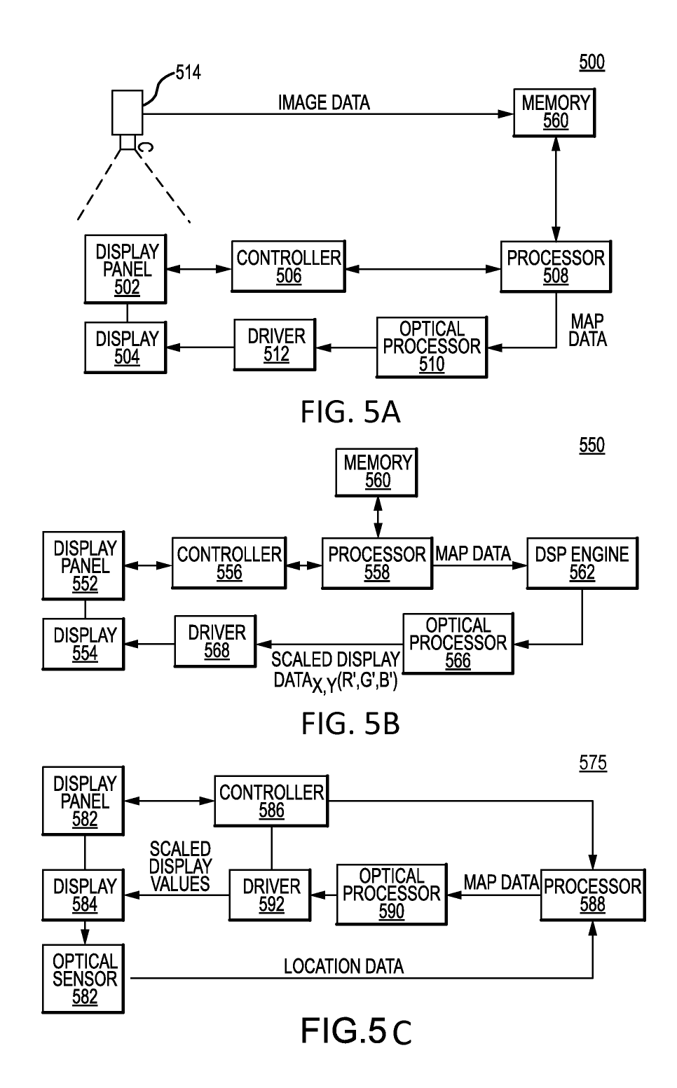

FIGS. 5A-5C are diagrams illustrating examples of display calibration systems in accordance with one or more implementations. FIG. 5A is a diagram illustrating an example of a closed-loop calibration system 500 in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The optical distortion compensation of display system 102 can be performed in conjunction with the closed-loop calibration process, depending on implementation. Closed-loop calibration system 500 includes display panel 502, display 504, controller 506, processor 508, optical processor 510, display driver 512, camera 514 and memory 516. In one or more aspects, the components of closed-loop calibration system 500 may be included in a mobile device. As such, closed-loop calibration process may be performed during or after the manufacture of the mobile device.

In the closed-loop calibration process, a priori information may be stored in memory 532 (e.g., non-volatile memory or read-only memory (ROM)) to have access to information that indicates a display panel coordinate (e.g., x, y) having a certain signature (or mapping). Camera 514 may be configured to monitor alignments to determine offsets between an expected pixel location and an actual pixel location. In this regard, camera 514 captures images of display panel 502 and display 504 to record actual coordinates of the conductive layer traces and/or pixel elements. The images are converted into digital form and received by memory 516. In some aspects, an analog-to-digital converter (ADC) (not shown) may be coupled to camera 514 to convert the images into image data, or in the alternative, camera 514 may include the ADC as an embedded or integrated component. In some aspects, camera 514 can be located externally to a mobile device or any electronic device that is fabricated to carry the electrical components described herein.

Camera 514 also may be configured to have a color accuracy having minimal error and a relatively high resolution. The closed-loop calibration process can include measuring brightness level and color quality of display panel 502. In one or more aspects, closed-loop calibration system 500 is operable to detect blue accuracy by calculating certain locations on display panel 502 (e.g., less blue in first location, more blue in second location). In addition, any variations in color and/or brightness observed across display panel 502 can be increased or decreased based on the image data. The image data can provide intensity values for different frequencies at one or more locations on display panel 502. Assuming that display 504 is aligned with display panel 502; the adjustments can be based on the locations of the display panel 502.

In one or more aspects, camera 514 may be configured to detect distortions caused by the angle of viewing. Depending on the angle, there is a certain brightness level and contour along the x-y plane. That is, there is a different distortion between the different viewing angles. By way of example, the brightness level may decrease depending on the angle and distance between the user pupil and surface of display panel 502. In some implementations, closed-loop calibration system 500 can track eye (or pupil) movement to determine display calibration of the measured pupil angle. This calibration may apply to touch panels and non-touch panels.

In one or more aspects, closed-loop calibration system 500 can be operable in a non-visible light spectrum (e.g., infrared) where distortion can also occur. Camera 514, including an infrared light backlight (not shown), can be operable to capture images of objects bouncing back and forth between display panel 502 and display 504. These objects can cause photodiodes to be placed inside display 504, of which camera 514 may be configured to detect. The detected photodiodes can be processed into image data and translated into map data. The map data can be further processed to provide brightness/colorization correction or offset adjustment information to optical processor 510. In this regard, closed-loop calibration system 500 may be operable in infrared for calibrating display 504.

Processor 508 may read the image data from memory 516 to generate a compensation map that provides a template of the pixels located in display 504 and location of the conductive layer traces. In some aspects, optical processor 510 may receive the compensation map from processor 508 to compare the actual coordinates against the stored location data to determine one or more locations needing spatial correction. The spatial correction may be determined if the offsets exceed a threshold indicating an acceptable amount of displacement between display 504 and display panel 502. As such, optical processor 510 may generate scaled display values with offset values that alter the coordinate location of the pixels relative to display panel 502. In this respect, display 106 is realigned with display panel 502 to reduce the optical distortion caused by the misalignment. In some aspects, the display panel 502 may be moved to be realigned with display 504.

FIG. 5B is a diagram illustrating an example of a open-loop calibration system 550 in accordance with one or more implementations. Open-loop calibration system 550 includes display panel 552, display 554, controller 556, processor 558, memory 560, DSP engine 562, optical processor 566, and driver 568. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In the open-loop calibration process, open-loop calibration system 550 may be configured to generate test patterns based on a priori information provided at a manufacturing facility. The a priori information can be processed by processor 558 to generate map data, and fed to digital signal processor (DSP) engine 562 that computes long-term statistical averages of the a priori information to determine image correction on display panel 502. The long-term statistical averages determine a trend of expected locations to compute offsets. The image correction can include the offsets of the conductive layer traces and/or adjustments to display characteristic of the pixel elements to ensure that the optical distortion is within a certain tolerable threshold. The tolerable threshold value may be provided by a user of the mobile device or provided in advance by the manufacturing facility, and stored in memory 516 for access during the open-loop calibration process.

FIG. 5C is a diagram illustrating an example of calibration system 575 in accordance with one or more implementations. Calibration system 575 includes display panel 582, display 584, controller 586, processor 588, optical processor 590, driver 592 and optical sensor 594. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Calibration system 575 utilizes optical sensor 594 for auto-calibration of display 584 and display panel 582. Optical sensor 594 may be disposed in display 584 and configured to detect natural light traveling through display panel 582 and into display 584. Optical sensor 584 may be configured to measure the intensity of the received natural light received at one or more pixels in display 584. The measured intensity values may determine whether the pixels are being obstructed by a conductive layer trace disposed in display panel 582. By way of example, the conductive layer trace may be impacting the brightness level of light being emitted from the one or more pixels. Based on the map data received from processor 588, optical processor 590 may determine which conductive layer traces are obstructing the emitted light from display 584, and further determine which pixels in display 584 are being impacted.

Optical processor 590 may obtain information from the map data that relates to what amplitude and color correction would be necessary for the impacted pixels. To determine whether the obstruction is acceptable, optical processor 590 may be configured to perform long-term statistical averaging of multiple light conditions observed at the impacted pixels to determine the expected brightness levels at the impacted pixels. Different brightness levels may be expected between locations underneath a conductive layer trace and locations not underneath a conductive layer trace. In this regard, optical sensor 594 may be configured to collect brightness levels across multiple points in display 584. The averaging results can be used to determine the offset correction between display 584 and display panel 582.

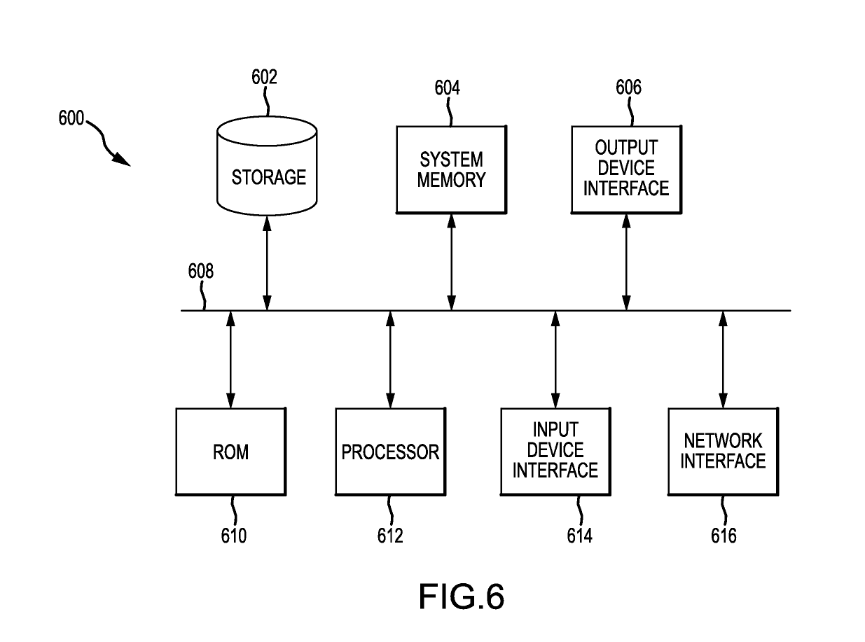

FIG. 6 conceptually illustrates an electronic system with which any implementations of the subject technology may be implemented. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Electronic system 600, for example, can be a switch, a router, or generally any electronic device that transmits signals over a network as an intermediate node (or a node communicatively coupled between endpoints). Such an electronic system includes various types of computer readable media and interfaces for various other types of computer readable media. Electronic system 600 includes bus 608, processing unit(s) 612, system memory 604, read-only memory (ROM) 610, permanent storage device 602, input device interface 614, output device interface 606, and network interface 616, or subsets and variations thereof.

In one or more aspects, electronic system 600 includes a computer-readable medium that stores processor-executable instructions of a method for display calibration that cause at least one of processing units 612 to perform operations including obtaining dimensional and location information of a conductive layer trace in a touch panel, determining a frequency response of a display characteristic for a pixel in a display that is located beneath or near the conductive layer trace based on the dimensional and location information, determining a correction value at one or more frequencies of the frequency response that improves the display characteristic, and outputting a control signal to the display that adjusts the pixel at the one or more frequencies with the correction value.

Referring to FIG. 6, bus 608 collectively represents all system, peripheral, and chipset buses that communicatively connect the numerous internal devices of electronic system 600. In one or more implementations, bus 608 communicatively connects processing unit(s) 612 with ROM 610, system memory 604, and permanent storage device 602. From these various memory units, processing unit(s) 612 retrieves instructions to execute and data to process in order to execute the processes of the subject technology. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. One or more implementations of the subject technology use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores any of the instructions and data that processing unit(s) 612 needs at runtime. In one or more implementations, the processes of the subject technology are stored in system memory 604, permanent storage device 602, and/or ROM 610. From these various memory units, processing unit(s) 612 retrieves instructions to execute and data to process in order to execute the processes of one or more implementations.

Bus 608 also connects to input and output device interfaces 614 and 606. Input device interface 614 enables a user to communicate information and select commands to the electronic system. Input devices used with input device interface 614 include, for example, alphanumeric keyboards and pointing devices (also called “cursor control devices”). Output device interface 606 enables, for example, the display of images generated by electronic system 600. Output devices used with output device interface 606 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, bus 608 also couples electronic system 600 to a network (not shown) through network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject technology.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method of compensating for optical distortion on a display panel, the method comprising:
determining one or more pixels in a display that need compensation for optical distortion on a display panel;
generating a mapping of the display comprising location information of the one or more pixels determined to need optical distortion compensation;
generating a control signal based on the mapping to control one or more display characteristics of the one or more pixels, the control signal comprising scaled display values for the one or more display characteristics to reduce the optical distortion on the display panel; and
outputting the control signal to the one or more pixels in the display.

2. The method of claim 1, wherein determining the one or more pixels comprises receiving a priori information of one or more conductive layer traces located in the display panel, wherein the one or more conductive layer traces are aligned with the one or more pixels in the display.

3. The method of claim 2, wherein receiving the a priori information comprises receiving dimensional and location information of the one or more conductive layer traces.

4. The method of claim 3, wherein receiving the dimensional and location information comprises:
receiving thickness information of the one or more conductive layer traces;
receiving width information of the one or more conductive layer traces; and
receiving a two-dimensional coordinate on the display panel that indicates where the one or more conductive layer traces is above or near the one or more pixels.

5. The method of claim 3, further comprising:
determining a frequency response of the one or more pixels in the display located beneath or near the one or more conductive layer traces based on the dimensional and location information.

6. The method of claim 5, wherein generating the control signal comprises determining the scaled display values for one or more frequencies of the frequency response to alter the one or more display characteristics of the one or more pixels from original display values to the scaled display values.

7. The method of claim 1, wherein outputting the control signal comprises supplying the mapping in the control signal to locate the one or more pixels that need the optical distortion compensation.

8. The method of claim 1, wherein determining the one or more pixels comprises receiving a priori information of one or more conductive layer traces located in the display panel, the a priori information comprising offset values based on location differences between the one or more pixels and the one or more conductive layer traces.

9. The method of claim 1, wherein determining the one or more pixels comprises receiving a priori information of one or more conductive layer traces located in the display panel, wherein the one or more conductive layer traces are misaligned with the one or more pixels in the display.

10. The method of claim 9, further comprising:
processing the a priori information with long-term statistical averages of user inputs received via the display panel to determine one or more offsets between the one or more pixels and the one or more conductive layer traces; and
supplying the one or more offsets in the control signal to cause the display panel to be realigned with respect to the display.

11. The method of claim 1, wherein determining the one or more pixels comprises:
capturing images of the display panel;
generating image data from the captured images;
generating long-term statistical averages of the image data to determine expected display characteristics of the one or more pixels; and
comparing actual display characteristics of the one or more pixels based on the image data with the expected display characteristics of the one or more pixels based on the long-term statistical averages to determine one or more locations on the display panel with optical distortion.

12. The method of claim 11, further comprising:
determining a gain to adjust the one or more display characteristics of the one or more pixels by a defined percentage.

13. The method of claim 1, wherein determining the one or more pixels comprises receiving sensor information from one or more optical sensors disposed in the display and relative to the one or more pixels, the sensor information comprising optical measurements of natural light received at the one or more pixels via the display panel.

14. The method of claim 13, further comprising:
determining if one or more pixels in the display are located beneath or near one or more conductive layer traces based on the sensor information,
wherein the control signal with the scaled display values is sent to the one or more pixels determined to be located beneath or near the one or more conductive layer traces.

15. The method of claim 14, further comprising:
determining one or more pixels located adjacent to the one or more pixels located beneath or near the one or more conductive layer traces,
wherein the adjacent pixels receive scaled display values that are different than the one or more pixels obstructed by the one or more conductive layer traces.

16. A display system comprising:
a display panel comprising a plurality of conductive layers arranged orthogonally to one another to form conductive layer traces on the display panel;
a display coupled to the display panel; and
a processor coupled to the display panel configured to:
determine one or more pixels in the display that need compensation for optical distortion on the display panel;
generate a mapping of the display comprising location information of the one or more pixels determined to need optical distortion compensation;
generate a control signal based on the mapping to control one or more display characteristics of the one or more pixels, the control signal comprising scaled display values for the one or more display characteristics to reduce the optical distortion on the display panel; and
output the control signal to the one or more pixels in the display, wherein the one or more pixels are located beneath or near the conductive layer traces.

17. The display system of claim 16, wherein the display comprises an optical sensor configured to generate one or more optical measurements of natural light received via the display panel.

18. The display system of claim 16, wherein the processor is configured to output a second control signal to pixels located adjacent to the one or more pixels, wherein the second control signal is configured to cause a decrease in magnitude of one or more display characteristics of the adjacent pixels.

19. The display system of claim 18, wherein the processor is configured to output the control signal and the second control signal at a same time to adjust the one or more pixels located beneath or near the conductive layer traces while adjusting the adjacent pixels.

20. The display system of claim 16, wherein the processor is configured to output a third control signal to uniformly adjust display characteristics of pixels across the display by a defined percentage.
